(19) United States
(12) Patent Application Publication
(10) Pub. No.: US 2005/0254922 A1
(43) Pub. Date: Nov. 17, 2005

(54) Grain bin sweep and method of assembly

(75) Inventors: Arvid James Berreau, Round Lake, MN (US); Lyndon John Hass, George, IA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Sudenga Industries, Inc., George, IA (US)

(21) Appl. No.: 10/844,121

(22) Filed: May 12, 2004

(51) Int. Cl. B65G 1/00

(52) U.S. Cl. 414/310

(57) ABSTRACT

A support frame for a grain bin sweep has an open interconnected framework which allows grain to flow through the frame. The frame is comprised of panels which are assembled together to form an open structure frame. The structure of the frame allows for easy mobility and assembly while still able to withstand the tremendous pressure exerted by large amounts of grain disposed on top of the grain bin sweep in a grain bin.

### CROSS-REFERENCE TO RELATED APPLICATION(S)

None

### BACKGROUND OF THE INVENTION

This invention relates to bin sweeps for moving and clearing of grain and other materials from silos, grain bins and similar storage units. Specifically, this invention relates to an open support frame that helps to support the auger of a bin sweep.

A grain bin sweep is generally found at the bottom of a grain bin containing a flat bottom floor. Typically, the grain bin has a circular horizontal cross-section. Diameters of grain bins vary from several feet to over one hundred feet. A grain sweep must cover, at a minimum, the radius of the bin so that it is able to sweep the entire area of the bin as it rotates about an axis in the center of the grain bin.

Commonly, an interior grain storage cavity of a grain bin or silo is filled with grain while the grain sweep is positioned at the bottom of the silo. Therefore, the grain sweep usually has a lot of weight (from the grain) pressing down upon it. The support frame for a grain sweep is typically adjacent to its auger and helps to support the auger and maintain the integrity of the sweep arm structure, especially when grain is poured into the bin and the weight of the grain is being placed on the grain sweep. Generally, grain sweep support frames have included solid material sheets, panels, or components (without multiple holes or openings to allow for the free flow of materials through the support frame).

To remove the grain from a bin, an opening at the bottom of the bin is opened to allow the grain to flow through by gravity. The grain flows like a viscous fluid much like the sand in an hourglass. Grain will flow into the floor opening until flow from gravity stops leaving grain at the sides of the bin resting at the angle of repose due to the flat floor surface and the opening being in the floor of the grain bin. The empty space in the bin is the shape of an inverted cone with the point at the floor opening and the circular base at the top level of the remaining grain. The grain remaining in the bin must be removed. The grain sweep in a bin removes the remaining grain that will not be moved by gravity alone.

As the grain flows through that opening, the grain sweep (which is initially disposed in the bin before the grain is placed in the bin) is also placed under a tremendous amount of pressure by the flowing grain and changing weight dynamics placed upon it. The downward pressure created from the flow of grain is so great that at times, the sweep arm including the support frame, auger and backshield become damaged (i.e., crushed or warped).

Another problem with most grain sweeps is that they are difficult to transport and difficult to assemble within a grain bin because the frame is constructed as one structure. This makes if difficult to bring that structure into an existing grain bin, and to position, assemble and install the frame because of the length of the support frame. In addition, the repair of the grain sweep may require the removal of the frame from the bin, which is inconvenient because of its size. A typical grain bin sweep is custom made for a specific grain bin and its particular size. This means that the grain sweep cannot be easily removed and taken to another silo, especially one that is of a different size.

Therefore, a grain sweep having a frame that is easy to assemble and maneuver in and out of grain bins is desirable. Additionally, such a frame should be able to withstand the tremendous amount of pressure exerted on it by the weight and movement of the grain in the grain bin without becoming damaged or destroyed.

### BRIEF SUMMARY OF THE INVENTION

The present invention is directed to the structure of a support frame for a grain bin sweep that can be used inside a grain bin. The support frame is comprised of several longitudinally extending panels that when assembled create an open interconnected design. The panels are attached together on their longitudinal sides to create an open structure which allows for the free flow of grain through the frame. In one embodiment, additional panel sections can be added to the end of the frame in order to increase the overall length of the frame to a specified size.

In one embodiment, the support frame is triangular in shape (when viewed laterally) and is comprised of three panels attached together along the longitudinal sides of each respective panel. The panel assembly design of the structure of the frame makes it easy to bring sections of the frame into a grain bin and to assemble them in the grain bins as they are easy to place into position. The open framework of the panels also make the panels lighter and easier to maneuver.

### BRIEF DESCRIPTION OF THE DRAWINGS

FIG. 1 is a top view of a grain bin sweep of the present invention as it would be used inside of a grain bin.

FIG. 2 is a front perspective view of the inventive grain bin sweep.

FIG. 3 is a back perspective view of the inventive grain bin sweep.

FIG. 4 is an exploded view of portions of the inventive grain bin sweep.

FIG. 5 is a side view of one support frame panel which is assembled to define a support frame for the inventive grain bin sweep.

FIG. 6 is a side view of a support frame comprised of several sections.

While the above-identified drawings set forth several embodiments of the present invention, other embodiments are also contemplated, as noted in the discussion. In all cases, this disclosure presents the present invention by way of representation and not limitation. It should be understood that numerous other modifications and embodiments can be devised by those skilled in the art which fall within the scope and spirit of the principles of this invention.

### DETAILED DESCRIPTION

The present invention allows for the free flow of grain through the support structure while still assisting in providing additional strength to the sweep arm. The present invention also allows for ease of assembly of a support frame within a grain storage facility. The present invention is further explained with reference to the drawing figures, wherein like structures are referred to by like numbers throughout the several views.

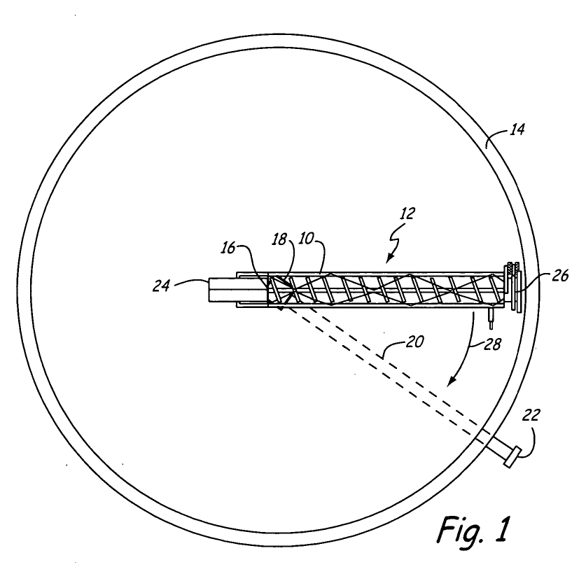

FIG. 1 shows a top view of support frame 10 as it would appear in use on bin sweep 12 in grain bin 14. Grain bin 14 is a storage facility, typically cylindrical, well known within the art. Bin sweep 12 rotationally moves around pivot axis 16 within grain bin 14. Bin sweep 12 conveys grain in the grain bin 14 from the outer circumference of grain bin 14 to a floor opening 18. Typically, floor opening 18 is centrally located within the bin with pivot axis 16 centrally located within the area of floor opening 18. Upon reaching floor opening 18, the contents of the grain bin 14 drop onto a conveyor 20. The grain is transported out of grain bin 14 via conveyor 20. Typically, conveyor 20 is a screw auger within an enclosed tube. The screw auger transports the stored grain through conveyor 20 to a discharge opening 22 which provides access to the grain outside of grain bin 14.

Bin sweep 12 has a first support structure 24 connected at a first end which rotates around pivot axis 16. First support structure 24 can be comprised of any suitable means which allow for rotation around pivotal axis 16 which may include, but is not limited to, a pivot axis housing unit, a motor and motor cover assembly. Bin sweep 12 also has a second support structure 26 at a second end. Bin sweep 12 moves radially around grain bin 14 in a direction noted by arrow 28. Second support structure 26 can be comprised of any suitable means which would be able to support the second end of bin sweep 12 and aid in the maneuvering of the entire bin sweep 12. Suitable means may include, but is not limited to, mechanical tractors, motorized tractors or any mobile support frame which would be able to move in accordance with bin sweep 12. The movement of bin sweep 12 can be facilitated through any suitable means which may include, but is not limited to, wheels, tracks and rail systems.

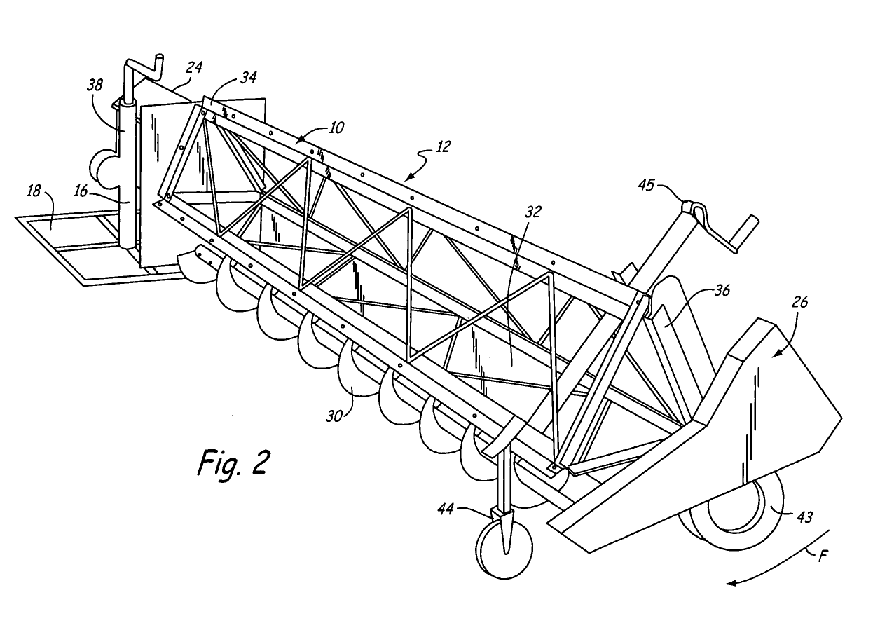

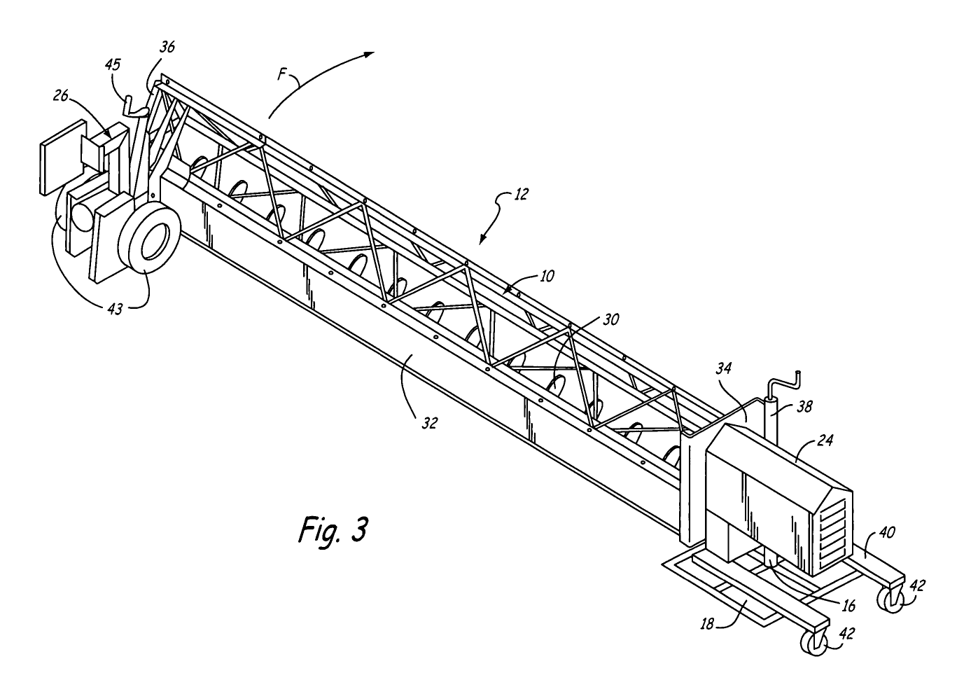

Support frame 10 is shown in greater detail in FIG. 2 and FIG. 3, which are a front and rear perspective views respectively, of support frame 10 as it would appear on a typical bin sweep 12. Bin sweep 12 comprises a support frame 10 that has a first end 34 and second end 36, and is further comprised of the first support structure 24, the second support structure 26, an auger 30 containing a first end connected adjacent to the first support structure 24 and a second end connected adjacent to second support structure 26, and a backshield 32 for the auger 30. Support frame 10 comprises an elongated open framework having a first end 34 connected to the first support structure 24 and a second end 36 connected to second support structure 26.

First support structure 24 is mounted to pivot centrally about floor opening 18 about pivotal axis 16. In one embodiment, pivot axis 16 is a rod extending vertically from the center of floor opening 18. A round metal tube having an inner diameter nominally larger the diameter of the rod is attached to the bin sweep 12. This design allows for rotational movement of the tube about the rod of pivotal axis 16. In the embodiment pictured in FIG. 3, the round metal tube is the base structure of a hand jack 38 attached to first support structure 24. The hand jack 38 allows for adjusting the height of first support structure 24. First support structure 24 contains a dolly 40 which raises first support structure 24 above floor opening 18. The dolly 40 supports the motor of first support structure 24 as well as an inner portion of bin sweep 12. The motor of first support structure 24 provides the power to turn the auger 30 about a generally horizontal axis. Castors 42 on the dolly 40 aid in support of the motor above floor opening 18 as well as permit rotational movement about pivot axis 16. The hand jack 38 is attached to the dolly 40 to provide adjustability of the height of the dolly 40 relative to the floor of the grain bin.

Second support structure 26 is located at the opposite side of bin sweep 12 as first support structure 24. In the preferred embodiment, second support structure 26 is comprised of a motorized tractor attached to the second end 36 of support frame 10. The motorized tractor provides a motive force on support wheels 43 mounted at the end of bin sweep 12 to move the structure forward in direction of arrow F in FIGS. 2 and 3 and thus rotate about pivot axis 16. The second support structure 26 is adjacent to the second end of auger 30, with support wheel 43 being connected to the second support structure 26. In the embodiment shown in FIG. 2, second support structure 26 also comprises castor 44 and hand jack 45. Castor 44 is attached to support frame 10. Castor 44 assures that second end 36 of support frame 10 is held at a height such that auger 30 does not contact the floor of grain bin 14. Castor 44 also supports the support frame 10. As it is preferable to get as much grain out of the bin as possible using bin sweep 12, the bin sweep 12 should be positioned so that auger 30 is as close as possible to the grain bin floor without contacting it. When auger 30 contacts the floor of grain bin 14, either the flighting of auger 30 or the floor of grain bin 14, or both, will wear or catch and cause substantial damage to either.

The auger 30 is connected between first support structure 24 and second support structure 26. Auger 30 conveys stored grain from the outside circumference of grain bin 14 to the center of the bin which contains floor opening 18. Auger 30 is comprised of a central rod or pipe with a sized helical flighting attached thereto, as is common in the art. Auger 30 may be comprised of either metal or polymers. The length of the auger 30 is nominally that of the length of the support frame 10.

The auger 30 is supported between first support structure 24 and second support structure 26 by support frame 10. Support frame 10 can be connected to auger 30, first support structure 24 and second support structure 26 through any suitable means which may include, but is not limited to, bolting, welding, clamping and soldering, and suitable bearings to permit auger rotation. Underneath support frame 10 and adjacent to auger 30 is backshield 32.

Backshield 32 attaches to support frame 10, and optionally also attaches first support structure 24 and second support structure 26. In one embodiment attachment of the backshield 32 to support frame 10 is accomplished by use of suitable fasteners, such as bolts. This allows for a stable but removable joining of these components. Alternatively, backshield 32 is attached to support frame 10 via a mechanical locking system incorporating spring loaded clips, cams, or similar devices. Readily separable attachment between backshield 32 and support frame 10 promotes mobility of the bin sweep 12 by allowing for easy assembly and disassembly; however semi-permanent or permanent attachment, such as welding, is also envisioned as an embodiment. Backshield 32 assures grain is conveyed to floor opening 18 by hindering grain kernels from being thrown from the front side of bin sweep 12 to the back side of bin sweep 12 and out of the path of auger 30. Grain moves along the flighting of screw auger 30 towards floor opening 18 with backshield 32 holding grain in place until the grain is moved by the auger 30.

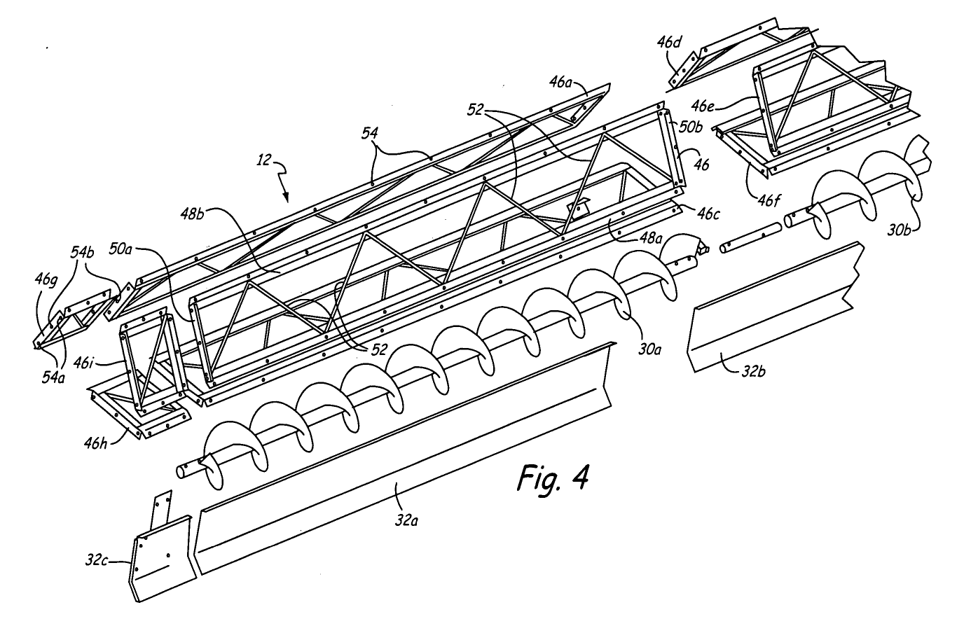

FIG. 4 is an exploded view of support frame 10. In one embodiment, support frame 10 comprises three panels 46a, 46b and 46c. Each panel 46 has an open interconnected framework which is comprised of an exterior frame panel and a series of cross supports 52 that are attached to the interior of frame panel. In an alternate embodiment (not pictured), support frame 10 comprises a plurality of elongated beams interconnected with a series of cross supports. Preferably, the beams and cross supports form an elongated triangular prism, although other shapes such as squares and trapezoids are envisioned.

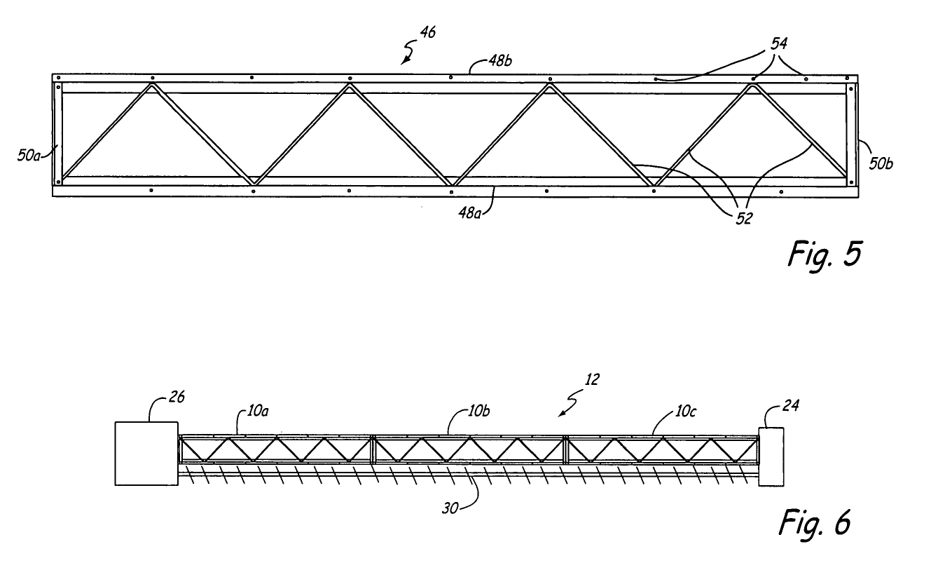

As illustrated in FIGS. 4 and 5, each frame panel 46 is comprised of four members, a pair of long side bars 48a, 48b, and a pair of short side bars 50a, 50b. In one embodiment, the panel 46 is rectangular. Short side bars 50a, 50b and long side bars 48a, 48b form a rectangular frame where short side bars 50a and 50b are parallel to each other and long side bars 48a and 48b are parallel to each other. Short side bars 50a, 50b and long side bars 48a, 48b are perpendicular to each other. In an exemplary embodiment, the ends of short side bars 50a, 50b and long side bars 48a, 48b are welded together, though the sides can be connected by any suitable means including, but not limited to bolts, adhesives and connecting joints.

In the exemplary embodiment, long side bars 48a and 48b are made of metal and fabricated to have a center bend that creates an obtuse angle of approximately 150 degrees in the longitudinal direction. This embodiment allows for constructing panels 46 that can be assembled into a frame having the shape of an equilateral triangular prism. Short side bars 50a and 50b are similarly fabricated from metal, but contain a 90 degree bend along the center of the length of the bars, or are constructed from angle iron. In the exemplary embodiment, the long sides of a panel 46 would be approximately ten feet long while the short sides would be approximately one and a half feet long. The approximate weight of a panel 46 that is the size of this exemplary embodiment would be approximately 29.2 pounds. Panel sizes can range from approximately one foot to forty feet in length. Side bars 50a, 50b and 48a, 48b are connected in such a manner as to provide a generally planar surface with short side bars 50a, 50b having one side perpendicular to the planar surface and long side bars 48a, 48b having a side that extends 30 degrees from the planar surface.

In the exemplary embodiment, the side bars, 50a, 50b and 48a, 48b, have a plurality of holes 54 on the sides that are perpendicular or at an angle to the planar surface, respectively. The side of short side bars 50a and 50b perpendicular to the side that attaches to the long side bars 48a, 48b contains prefabricated holes. This allows for easy connection of multiple sections of support frame 10, such as panels 46a, 46b and 46c with 46d, 46e and 46f and 46g, 46h and 46i as pictured in FIG. 4. Outer holes 54a are placed at approximately the center of the overlap regions between short side bars 50a and 50b with long side bars 48a and 48b, and an additional hole 54b is placed at an equal distance between the outer holes.

The holes 54 for the long side bars, 48a, 48b are similarly fabricated in a size equal to that of the holes 54 in the short side bars. The holes 54 are all on the center line of the angled sides of the long side bars 48a and 48b adjacent the planar surface created by all side bars 48a, 48b and 50a, 50b. In the exemplary embodiment, the holes 54 are intended to connect the panels 46a, 46b and 46c to each other to form the triangular shaped frame by allowing bolting of the frames through the holes 54. Other suitable means, without holes, can also be used to connect the frames, including, but not limited to welding, brackets and joint connectors.

In FIG. 5, a side view of a singular panel 46 shows that interconnected within the pairs of long side bars 48a, 48b and short side bars 50a, 50b are the series of cross supports 52 which together form an open panel with cross structures. The cross supports 52 are positioned on the planar surface created by the long side bars 48a, 48b and short side bars 50a, 50b. In an exemplary embodiment, cross supports 52 are metal rods approximately 0.38 inches in diameter and approximately 41 inches long with an approximate weight of 1.28 pounds. To create the interconnected structure with cross supports 52 in the exemplary embodiment, a rod comprising cross support 52 is bent in at approximately a ninety degree angle at approximately 20.42 inches on the length of cross support 52 so that cross support 52 creates a V-shape. The bend is made in this area so that cross support 52 is approximately equal in length on either side of the bent area. Cross support 52 is then spot welded at the ends and bent area to long side bars 48a, 48b and short side bars 50a, 50b. Typically, four bent cross supports 52 are needed to for a 10 feet section frame panel 46. The cross supports 52 and long and short side bars 48a, 48b and 50a and 50b create an open cross structure which provides additional strength to the structure of support frame 10 by distributing common stresses to support frame 10.

In another exemplary embodiment, the interconnected framework is created with individual cross supports 52 that are approximately 20.42 inches in length. Cross supports 52 are then placed on the same plane as the pairs of long side bars 48a, 48b and short side bars 50a, 50bbut at an angle so that a first end of cross support 52 is adjacent to the second end of another cross support 52 to create a V-shape. The ends of cross supports 52 are then spot welded to long side bars 48a, 48b and short side bars 50a, 50b. Typically, eight cross supports 52 are used for a 10 feet section of panel 46, but other geometries are envisioned for varying lengths such as those illustrated in FIGS. 2 and 3. Individual cross supports 52 are also used to use create smaller frame panels 46 such as one foot section frame panels 46g, 46h and 46i, as shown in FIG. 4. In the one foot section frame panels 46g, 46h and 46i, a single cross support 52, with the ends placed in the corners of the rectangular frame formed by short side bars 50a, 50b and long side bars 48a, 48b, creates the open framework.

The smaller frame panels 46g, 46h and 46i serve multiple purposes. First, the smaller panels 46g-i can be preassembled and attached to first support structure 24 prior to attaching additional frame panels 46 to the bin sweep 12. This permits using a more stabilized and elaborate attachment method aiding in structural support of the bin sweep 12 at first support structure 24. This is important as the motor for driving auger 30 is contained on first support structure 24, and can generate much stress due to vibrations associated with the powered system. Second, with attachment to standardized support panels, such as the preferred embodiment of 10 feet, the smaller panels 46g, 46h and 46i allow creating sweep arms of varying length.

Once the length of the bin sweep has been determined and panels 46 have been chosen, the bin sweep 12 is then assembled in a grain bin 14 by bringing in the individual panels 46a, 46b, 46c, 46d, 46e and 46f and other pieces, including the auger 30 and backshield 32, into the grain bin 14. Frame panels 46a, 46b, and 46c, auger 30a and backshield 32a are joined with frame panels 46d, 46e and 46f, auger 30b, and backshield 32b, respectively as illustrated in FIG. 4. The individual frame panels 46a, 46b, and 46c and 46d, 46e and 46f are attached to form support frame 10 which laterally has a triangular shape.

As seen in FIG. 6, multiple support frames 10a, 10b, and 10c are attached to lengthen the frame to a desired length. The auger 30 is then rotatably supported in the area below the extended support frame composed of 10a, 10b, and 10c. Once the auger 30 has been attached, the backshield 32 (not pictured) is attached adjacent to the auger 30. Typically, the auger 30 and backshield 32 are installed in similarly sized panel lengths as the length of support frames 10a, 10b and 10c. The first and second frame supports 24 and 26 that help to facilitate the movement of support frame 10 are then attached to the first end 34 and second end 36 of the extended support frame, assuring the first frame support 24 is positioned about pivot axis 16.

The open interconnected framework of the present invention allows for support of an auger 30 and a bin sweep 12 without damage from warping or being crushed by the weight of grain piled over the bin sweep 12. The structure described of panels 46 with cross supports 52 create an open and strong truss that can withstand large forces exerted onto the structure. Thus, if the bin sweep 12 is placed in a bin and filled with grain, the sweep will not be deformed. The auger 30 will remain in its intended position to optimally remove the grain. The support frame 10 also provides strength to counter the dynamic forces of flowing grain while a bin is being emptied. Additionally, the individual panels 46a, 46b, 46c, 46d, 46e, 46f, 46g, 46h and 46i allow for customization and ease of assembly of the sweep within a grain bin 14.

The open lattice structure of support frame 10 also does not impede the flow of grain. Grain can fall freely through the frame support. This becomes especially important at the far ends of the bin sweep 12. When emptying grain bin 14, the grain flows freely to floor opening 18 from the outer edges until the grain comes to rest at the angle of repose. The angle of repose varies with the placement of bin floor holes 18 and the properties of the stored material, including type of grain and moisture content, but will leave the height of grain remaining in the bin at the outer edges above the height of the bin sweep 12 with support frame 10. Once grain rests at the angle of repose, the bin sweep 12 is activated to empty the bin. Grain is allowed to flow down through the support frame 10 to be removed by auger 30 as the tractor of second support structure 26 moves the bin sweep 12 around the grain bin 14. The bin sweep 12 is installed either before the grain bin 14 is filled, or may be placed in the bin after the grain bin 14 has been partially emptied and the grain has come to rest at the angle of repose.

Although the present invention has been described with reference to preferred embodiments, workers skilled in the art will recognize that changes may be made in form and detail without departing from the spirit and scope of the invention.

1. A grain bin sweep apparatus with a frame which allows for grain movement vertically through the frame, the sweep apparatus comprising:
a longitudinally extending auger with a first end and a second end;
a first auger support structure adjacent to a first end of the auger;
a second auger support structure adjacent to a second end of the auger;
a support wheel connected to the second auger support structure which aides in the movement of the auger as it moves within a grain bin;
a longitudinal sweep panel adjacent to the auger which aides in the movement of the grain; and
a longitudinal frame adjacent to the auger wherein the frame has an open interconnected framework.

2. The sweep apparatus of claim 1 wherein laterally, the frame adjacent to the auger has a triangular shape.

3. The sweep apparatus of claim 2 wherein the frame adjacent to the auger further comprises three elongated beams.

4. The sweep apparatus of claim 3 wherein the elongated beams are interconnected by a series of cross supports.

5. The sweep apparatus of claim 1 wherein the frame is comprised of a plurality of open panels, wherein each panel has a plurality of cross structures.

6. A grain bin sweep comprising:
an auger:
a first auger support structure adjacent to a first end of the auger wherein the first support structure rotates about a vertical axis;
a second auger support structure adjacent to a second end of the auger; and
a support frame connecting the first auger support and second auger support together and operably supporting the auger, wherein the support frame is defined by an open lattice structure.

7. The grain bin sweep of claim 6 wherein laterally, the support frame has a triangular shape.

8. The grain bin sweep of claim 7 wherein the support frame further comprises three elongated panels, each panel comprising two long side members and two short side members.

9. The grain bin sweep of claim 8 wherein the each panel is interconnected by a series of cross supports.

10. The grain bin sweep of claim 6 wherein the support frame is comprised of a plurality of open panels with cross structures.

11. A grain sweep comprising:
a support frame having an open interconnected framework, which allows for grain movement vertically through the frame, the framework being elongated and having a first end and a second end;
an auger supported by the frame; and
a grain sweep panel supported by the frame adjacent the auger.

12. The grain sweep of claim 11 wherein laterally, the support frame has a triangular shape.

13. The grain sweep of claim 12 wherein the support frame further comprises three elongated panels.

14. The grain sweep of claim 13 wherein the elongated panels are interconnected by a series of cross supports.

15. The grain sweep of claim 11 wherein the support frame is comprised of a plurality of open panels with cross structures.

16. A method of assembling a grain bin sweep, the method comprising:
providing at least three longitudinally extending frame panels, each panel having an open framework configuration;
positioning the frame panels within an interior grain storage cavity of a grain bin;
assembling the frame panels together to form a longitudinally extending frame which laterally has a triangular shape;
attaching a longitudinally extending auger to the frame;
attaching a longitudinally extending grain auger backshield to the frame adjacent the longitudinally extending auger; and
attaching frame supports at the ends of the frame, to facilitate controlled movement of the frame within the grain bin cavity.

17. The method of claim 16 further comprising:
adjusting a longitudinal length of the frame by connecting additional frame panels together longitudinally to define an overall frame length.

18. The method of claim 16 further comprising:
providing an auger and a grain auger backshield dimensioned to conform to the frame overall length.
